(19) United States
(12) Patent Application Publication
(10) Pub. No.: US 2025/0384361 A1
(43) Pub. Date: Dec. 18, 2025

(54) Automatic Detection Of Travel Keys

(71) Applicant: Oracle International Corporation, Redwood Shores, CA (US)

(72) Inventors: Prasad Nair, Thiruvananthapuram (IN); Oleksiy Turchyn, Cleveland Heights, OH (US); Deepa Gopikuttan Pillai, Trivandrum (IN); Gnana Antony Jayant Gnana Pragasam, Trivandrum (IN); Subin Kuttappan Stellal Mary, Trivandrum (IN); Gowtham Murugan, Thiruvananthapuram (IN); Abhijith Sathya, Thiruvananthapuram (IN); Parvathy Suresh, Thiruvananthapuram (IN); Abhiram Sreeraman Leela, Thiruvananthapuram (IN); Jitesh Ramanathu Valiyaveettil, Thiruvananthapuram (IN); Deni Mathew Simon, Thiruvananthapuram (IN)

(73) Assignee: Oracle International Corporation, Redwood Shores, CA (US)

(21) Appl. No.: 18/745,515

(22) Filed: Jun. 17, 2024

(51) Int. Cl. G06Q 10/047; G06Q 10/0631

(52) U.S. Cl. CPC G06Q 10/047; G06Q 10/06311

(57) ABSTRACT

Techniques for automatically detecting the optimum travel keys for geographical locations associated with field service activities are disclosed. In some embodiments, a system automatically determines corresponding travel keys for geographic locations based on locations elements of the geographic locations. The system then uses the determined travel keys in a practical application that involves determining a duration of travel between activities associated with the geographic locations and performing a function of a software application using the determined duration of travel.

### TECHNICAL FIELD

The present disclosure relates to software applications. In particular, the present disclosure relates to automatically detecting the optimum travel keys for geographical locations associated with field service activities for use by a software application.

### BACKGROUND

Software applications are often tasked with generating time-based predictions for activities that include travel. One approach for predicting travel duration is to represent locations as small geographical areas, termed travel keys. The software application may collect data, such as travel speeds and parking times, for each travel key to learn and extrapolate from historical travel data unique to the travel key.

The size of a travel key may impact the learning speed and accuracy of predicting travel times. For example, if the travel key covers too small an area, then there may not be enough reported travel data from which to quickly learn and formulate predictions. On the other hand, travel keys covering too large an area may lead to overgeneralized predictions that are inaccurate and not meaningful for a given activity. Currently, human users are relied upon to configure travel keys, which often leads to suboptimal learning and inaccurate predictions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a travel key detection system in accordance with one or more embodiments;

FIG. 2 illustrates an example set of operations of a method for automatically detecting travel keys in accordance with one or more embodiments;

FIG. 3 illustrates another example set of operations of a method for automatically detecting travel keys in accordance with one or more embodiments;

FIG. 4 illustrates an example graphical user interface in which a recommendation to schedule an activity for a particular time slot is presented in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. TRAVEL KEY DETECTION ARCHITECTURE
3. AUTOMATICALLY DETECTING TRAVEL KEYS
4. EXAMPLE EMBODIMENT
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. GENERAL OVERVIEW

A travel key may be composed of a combination of location elements of a corresponding geographic area, such as a combination of a country identifier (e.g., a country code) and at least a portion of a postal code (e.g., a zip code) of the geographic area. In some embodiments, a computer system may estimate the duration of travel for activities with locations spanning two travel keys or within the same travel key. The system may estimate travel duration based on historical data collected for activities completed within one or more travel keys. For example, the system may collect, for an individual travel key, airline (or straight-line) distance speeds, traffic flows, parking times, the duration of specific activities completed within the corresponding geographic area, and other intra-key statistical data. Additionally or alternatively, the system may collect data inter-key statistical data including historical travel durations between the two travel keys for previous activities that have been completed.

Embodiments herein automatically detect and configure the optimum travel keys for time-based prediction applications. If the area covered by each travel key is too small, then it may result in an insufficient amount of reported data per travel key. As a result, the system may not have enough data to estimate accurate travel durations. It will also take a lot of time to build accurate machine learning models to predict travel durations when the travel keys are too small. On the other hand, if the area covered by each travel key is too large, it may result in inaccurate estimations because the deviation between reported travel durations will be large as well, leading the machine learning model to overgeneralize.

In some embodiments, the system automatically determines corresponding travel keys for predicting travel durations associated with one or more activities based on locations elements of the geographic locations where the one or more activities occur. The system then uses the determined travel keys to estimate a duration of travel between activities associated with the geographic locations and perform a function of a software application using the determined duration of travel. In several examples described herein, the software application is a field service management (FSM) software application, and the activities include field service activities. However, many embodiments are applicable to other types of software applications and software functions.

In some embodiments, the travel keys comprise a combination of at least a portion of one of the location elements and at least a portion of another one of the location elements. The location elements comprise a country identifier and a postal code. The travel key configurations are not statically defined. The system may select, at runtime, the location elements and portions thereof for the travel keys to optimize model predictions. The system may automatically adjust the selected location elements and/or portions for a given travel key based on feedback to provide a balance between learning speeds and prediction accuracy.

In some embodiments, each travel key is generated using a formula that is selected based on the country identifier of the corresponding geographic location. For example, the system may select a formula from a plurality of formulas based on a country identifier of the geographic location, and each formula in the plurality of formulas may correspond to a different country identifier and be configured to generate travel keys.

In some embodiments, the system changes its configuration of the travel key in response to a determination that the current configuration of the travel key does not have a sufficient amount of corresponding historical data. For example, the system may determine that a first version of a travel key that corresponds to a first geographic area does not have a sufficient amount of corresponding historical data, and then, responsive to that determination, use a second version of the travel key that corresponds to a second geographic area that is larger than and encompasses the first geographic area. In one embodiment, the system may decrease the number of digits used from the postal code in order to increase the area covered by the travel key, and thereby increase the amount of corresponding historical data. If decreasing the number of digits is insufficient, the system may use the city name corresponding to the postal code instead of using postal code digits.

In some embodiments, the function of the software application for which the determined duration of travel is used comprises presenting the duration of travel on a computing device. Another function comprises presenting a recommendation to schedule an activity based on the duration of travel.

One or more embodiments described in this Specification and/or recited in the claims may not be included in this General Overview section.

### 2. TRAVEL KEY DETECTION ARCHITECTURE

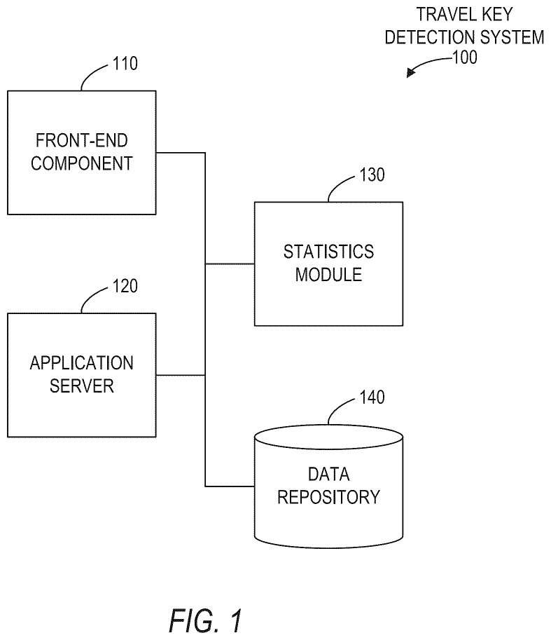

FIG. 1 illustrates a travel key detection system 100 in accordance with one or more embodiments. As illustrated in FIG. 1, travel key detection system 100 includes a front-end component 110, an application server 120, a statistics module 130, and a data repository 140. In one or more embodiments, the travel key detection system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The components of the travel key detection system 100 may communicate with one another via one or more computer networks. Furthermore, one or more components of the travel key detection system 100 may be implemented as part of a cloud network. Additional embodiments and/or examples relating to computer networks are described below in Section 5, titled “Computer Networks and Cloud Networks.”

In an embodiment, the front-end component 110 includes a web user interface (e.g., a web browser or mobile application) that facilitates communication between a user and components of the travel key detection system 100, enabling the user to interact with components of the travel key detection system 100. The front-end component 110 may include a graphical user interface that renders user interface elements and receives input via user interface elements. Examples of user interface elements include checkboxes, radio buttons, dropdown lists, list boxes, buttons, toggles, text fields, date and time selectors, command lines, sliders, pages, and forms. Different components of the user interface may be specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the graphical user interface is specified in one or more other languages, such as Java, C, or C++.

In one or more embodiments, the application server 120 hosts one or more software applications that access and use data that is learned by the statistics module 130 and stored in the data repository 140. In an embodiment, the application server 120 hosts a field service management (FSM) software application. An FSM software application includes features that are used to coordinate a company's resources, including employees and equipment, in work activities and operations off company property. The FSM software application may include a cloud-based FSM solution that helps businesses schedule, route, and equip mobile workers to complete service activities at a customer's home, office, or installed asset location. In some embodiments, the application server 120 computes travel keys based on configurations for travel keys that are learned by the statistics module 130. The application server 120 may also compute a duration of travel between activities using corresponding travel keys for the activities, and then perform one or more functions using the computed duration of travel.

In an embodiment, the statistics module 130 includes a machine learning algorithm that is configured to learn the optimal configurations for travel keys based on location elements of geographic locations and historical data of instances of travel between geographic locations. The statistics module 130 may learn the optimal configurations for travel keys by aggregating historical data including instances of travel between geographic locations to determine if an initial configuration of a travel key has a sufficient amount of corresponding historical data. The historical data may include intra-key and/or inter-key metrics collected from reports or tracking data. The intra-key and inter-key data may generally include time-based metrics from which the machine learning algorithm may extrapolate and perform statistical learned estimation. Example metrics may include airline distance speeds, traffic speeds, duration of travel between two different locations (within a travel key or across different travel keys), time to find a parking spot, and time to complete other activities.

In one or more embodiments, the statistics module 130 is configured to change its configuration of the travel key in response to a determination that the current configuration of the travel key does not have a sufficient amount of corresponding historical data. For example, the statistics module 130 may determine that a first version of a travel key that corresponds to a first geographic area does not have a sufficient amount of corresponding historical data, and then, responsive to that determination, use a second version of the travel key that corresponds to a second geographic area that is larger than and encompasses the first geographic area. In one embodiment, the system may decrease the number of digits used from the postal code in order to increase the area covered by the travel key, and thereby increase the amount of corresponding historical data. If decreasing the number of digits is insufficient, the statistics module 130 may use the city name corresponding to the postal code instead of using postal code digits. As more report data is received, the system may increase the number of digits to reduce the geographic area of a travel key, which may improve model accuracy when there is sufficient data from which to learn.

In some embodiments, the data repository 140 stores data provided by the front-end component 110, the application server 120, and the statistics module 130. For example, the data repository 140 may store corresponding sets of locations elements of geographic locations associated with activities, a plurality of different formulas for generating travel keys, and historical data including instances of travel between geographic locations associated with activities, where each instance of travel includes a corresponding duration of travel. In one or more embodiments, the data repository 140 is any type of storage unit and/or device (e.g., a file system, database, collection of tables, or any other storage mechanism) for storing data. Further, the data repository 140 may include multiple different storage units and/or devices. The multiple different storage units and/or devices may or may not be of the same type or located at the same physical site. Further, the data repository 140 may be implemented or executed on the same computing system as the application server 120 and the statistics module 130. Additionally, or alternatively, the data repository 140 may be implemented or executed on a computing system separate from the application server 120 and the statistics module 130. The data repository 140 may be communicatively coupled to the front-end component 110, the application server 120, and the statistics module 130 via a direct connection or via a network.

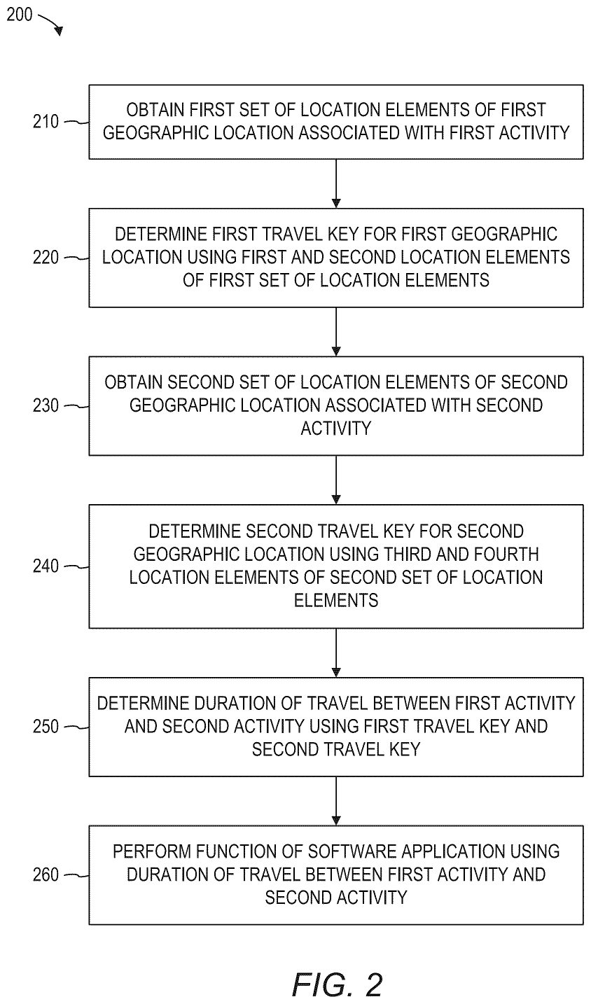

In one or more embodiments, the travel key detection system 100 refers to hardware and/or software configured to perform operations described herein for automatically detecting travel keys. Examples of operations for automatically detecting travel keys are described below with reference to FIG. 2.

In an embodiment, the travel key detection system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. AUTOMATICALLY DETECTING TRAVEL KEYS

FIG. 2 illustrates an example set of operations of a method 200 for automatically detecting travel keys in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, the travel key detection system 100 obtains a first set of location elements of a first geographic location associated with a first activity (Operation 210). Location elements may include the components of an address corresponding to a geographic location. For example, the first set of location elements of the first geographic location may include one or more of the following elements: street number, street name, city, postal code, state, province, and country. Other types of location elements are also within the scope of the present disclosure. In one or more embodiments, the first activity includes any time-consuming task that a resource performs. The first activity may include any field service activity, such as any work performed at a customer's site instead of a company's site. Examples of field service activities include delivery of goods or services, installation of products, and maintenance of products.

In an embodiment, the travel key detection system 100 obtains the first set of location elements of the first geographic location associated with the first activity via a user interface of the front-end component 110. For example, the front-end component 110 may display, on a computing device of a user, a user interface that is configured to enable the user to request the first activity. As part of the request, the user may enter or otherwise provide, via the user interface, the first set of location elements of the first geographic location at which the user is requesting the first activity to be performed.

In one or more embodiments, the travel key detection system 100 determines a first travel key for the first geographic location using a first location element of the first set of location elements and a second location element of the first set of locations elements (Operation 220). In some embodiments, the first location element comprises a first country identifier of the first geographic location, and the second location element comprises a first postal code of the first geographic location. The first country identifier may include a country code, which is a short alphanumeric identification code for countries and dependent areas. Other types of location elements may additionally or alternatively be used for the first and second location elements. The travel key detection system 100 may determine the first travel key for the first geographic location by combining at least a portion of the first location element and at least a portion of the second location element to form the first travel key. For example, the travel key detection system 100 may append at least a portion of the postal code of the first geographic location (e.g., the first five digits of the postal code) to the country code of the first geographic location to form the first travel key.

In some embodiments, the data repository 140 stores a plurality of formulas that each correspond to a different country identifier. Each formula in the plurality of formulas corresponds to a different country identifier and is configured to generate travel keys. In determining the first travel key, travel key detection system 100 may first select a first formula from the plurality of formulas based on a first country identifier of the first geographic location by scanning the data repository 140 to find the formula that corresponds to the first country identifier. The travel key detection system 100 may then generate the first travel key using the first formula based on the selection of the first formula.

In an embodiment, the travel key detection system 100 obtains a second set of location elements of a second geographic location associated with a second activity (Operation 230). The second set of location elements of the second geographic location may be of the same type as the first set of location elements of the first geographic location. For example, if the first set of location elements includes a street number, a street name, a city, a postal code, a state, and a country, then the second set of location elements may also include a street number, a street name, a city, a postal code, a state, and a country. Similar to the first activity discussed above, the second activity may include any time-consuming task that a resource performs. The second activity may include any field service activity, such as any work performed at a customer's site instead of a company's site, such as installation of products and maintenance of products.

In an embodiment, the travel key detection system 100 obtains the second set of location elements of the second geographic location associated with the second activity via a user interface of the front-end component 110. For example, the front-end component 110 may display, on a computing device of a user, a user interface that is configured to enable the user to request the second activity. As part of the request, the user may enter or otherwise provide, via the user interface, the second set of location elements of the second geographic location at which the user is requesting the second activity to be performed.

In an embodiment, the travel key detection system 100 determines a second travel key using a third location element of the second set of location elements and a fourth location element of the second set of location elements (Operation 240). In one or more embodiments, the third location element comprises a second country identifier of the second geographic location, and the fourth location element comprises a second postal code of the second geographic location. The second country identifier may include a country code. Other types of location elements may additionally or alternatively be used for the third and fourth location elements. The travel key detection system 100 may determine the second travel key for the second geographic location by combining at least a portion of the third location element and at least a portion of the fourth location element to form the second travel key. For example, the travel key detection system 100 may append at least a portion of the postal code of the second geographic location (e.g., the first five digits of the postal code) to the country code of the second geographic location to form the second travel key.

In determining the first travel key, travel key detection system 100 may first select a first formula from the plurality of formulas based on a first country identifier of the first geographic location by scanning the data repository 140 to find the formula that corresponds to the first country identifier. The travel key detection system 100 may then generate the first travel key using the first formula based on the selection of the first formula.

In an embodiment, the travel key components that are selected depend on the activity or activity category. For example, the amount of data reported within a given region may vary from one field service activity to another. The travel key detection system 100 may determine a size for a travel key based on how much historical data has been collected for the activity or activity category. Travel key detection system 100 may use the selected formula to generate a travel key covering an area of a size that is optimal for the associated activity given how much data has been reported for the activity or activity category. Generally, the size of the area covered by the travel key for an activity is smaller the greater the amount of historical data from which to extrapolate.

Additionally or alternatively, the travel key size may vary depending on the particular region where the activity will occur. The amount of data reported data may vary from one region to another. The travel key detection system 100 may use the selected formula to generate a travel key covering an area of a size that is optimal for a region given how much data has been collected in the region. As previously noted, the size of the area covered by the travel key for an activity is smaller the greater the amount of historical data from which to extrapolate. Thus, the configuration of a travel key may vary from region to region and activity to activity.

In an embodiment, the travel key detection system 100 determines a duration of travel between the first activity and the second activity using the first travel key and the second travel key (Operation 250). The travel key detection system 100 may determine the duration of travel between the first activity and the second activity by obtaining, from the data repository 140, a set of historical data comprising historical travel durations between the first travel key and the second travel key, and then computing the duration of travel between the first activity and the second activity based on the historical travel durations between the first travel key and the second travel key. For example, the travel key detection system 100 may compute the average of the historical travel duration between the first travel key and the second travel key, and then use the computed average as the duration of travel between the first activity and the second activity.

In an embodiment, the travel key detection system 100 builds and uses a model to predict travel times between two activities. The statistical learned estimation model may be built by one or more machine learning algorithms, which may extrapolate from learned patterns in the intra and/or inter-key historical metric data. For example, a first statistical learned estimation may be computed based on the historical travel times between two locations as determined from inter-key metrics. The second learned estimation may be computed as a function of values collected for individual travel keys. An example travel time estimate may be computed as follows: travel key A weight*(distance traveled in travel key A/average travel speed in travel key A+ average parking time in travel key A)+travel key B weight*(distance traveled in travel key B/average travel speed in travel key B+average parking time in travel key B). In the above formula, the sum of the weights add to 1. Travel key A and B may be the same travel key or different travel key depending on the location of the activities. The estimates may also vary depending on the activity or activity categories involved. For instance, the average travel speeds and parking times may vary depending on the particular activity. The size of the travel key may vary from one activity to another, which may further impact the model predictions. The statistical learned estimations may be adjusted over time as more data is collected.

In one or more embodiments, the travel key detection system 100 performs a function of a software application using the duration of travel between the first activity and the second activity (Operation 260). The software application may comprise a field service management (FSM) software application. However, other types of software applications are also within the scope of the present disclosure. In one embodiment, the performing of the function of the software application includes determining a particular time slot for the second activity based on the duration of travel between the first activity and the second activity, and then presenting, on computing device, a recommendation to schedule the second activity for the particular time slot. In another embodiments, the performing of the function of the software application includes determining a first particular time slot for the first activity and a second particular time slot for the second activity based on the duration of travel between the first activity and the second activity, and then presenting, on a computing device, a recommendation to schedule the first activity for the first particular time slot and the second activity for the second particular time slot.

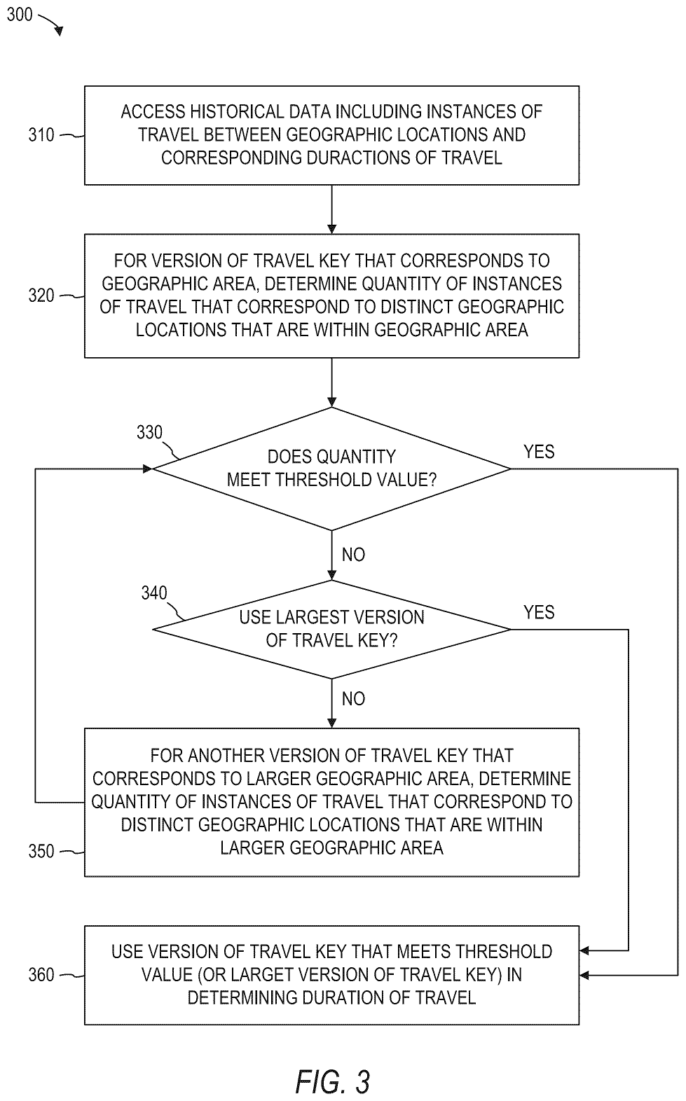

FIG. 3 illustrates another example set of operations of a method 300 for automatically detecting travel keys in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

In an embodiment, the travel key detection system 100 accesses historical data stored in the data repository 140 (Operation 310). The historical data comprises a plurality of instances of travel between geographic locations. These instances of travel may be recorded based on users of the application server 120 using a software application that manages activities, such as a FSM software application that manages scheduling and booking of appointments for the activities. Each instance of travel in the plurality of instances of travel may include a corresponding duration of travel indicating a length of time that it took for a user who was assigned to perform the activity to travel between geographic locations.

In some embodiments, the travel key detection system 100, for a first version of a travel key that corresponds to a first geographic area, determines a first quantity of the plurality of instances that correspond to distinct geographic locations that are within the first geographic area (Operation 320). In one example, the first version of the travel key may include a combination of a country code corresponding to the first geographic area and a first set of consecutive digits of a postal code that corresponds to the first geographic area. In this example, the travel key detection system 10 determines a first quantity of the plurality of instances that correspond to the distinct geographic locations that have corresponding postal codes that include the first set of consecutive digits of the postal code. For example, if “9501” are the first set of consecutive digits of the postal code, then travel key detection system 100 may determine the quantity of instances that corresponds to distinct geographic locations that have postal codes that include “9501” as their first digits, such as “95010,” “95011,” “95012,” “95013,” “95014,” “95015,” “95016,” “95017,” “95018, and” “95019.”

In an embodiment, the travel key detection system 100 determines whether the first quantity meets a threshold value (Operation 330). For example, the travel key detection system 100 may determine whether the first quantity is equal to or greater than one-hundred. However, the threshold value may be configured differently depending on how much data an administrator believes is necessary for the travel key detection system 100 to accurately predict durations of travel using the corresponding travel key that produced the first quantity.

Additionally or alternatively, the threshold values and/or other model parameters may be automatically adjusted using machine learning by minimizing an error function associated with model predictions. For example, the travel key detection system 100 may compare predicted travel duration times to observed travel duration times across travel keys of varying sizes, regions, and/or activities. The travel key detection system 100 may determine which travel key size yields the lowest estimation error for a given set of model parameters and select the parameters accordingly. The model parameters may be tuned as additional data is received.

If the travel key detection system 100 determines that the first quantity does meet the threshold value, then the travel key detection system 100 may proceed to use the corresponding version of the travel key in the determination of the duration of travel (Operation 360). For example, the travel key detection system 100 may use the corresponding version of the travel key that resulted in the satisfying of the threshold value in the determination of the duration of travel between the first activity and the second activity (Operation 250) in FIG. 2.

If the travel key detection system 100 determines that the first quantity does not meet the threshold value, then the travel key detection system 100 may determine whether it should use a default largest version of the travel key. The default largest version of the travel key may act as a final option if a gradual enlargement of the geographic area that the current version of the travel key corresponds to is insufficient to provide enough historical data to accurately predict durations of travel. For example, if gradually removing the last digit from the consecutive set of digits of the postal code is insufficient to result in enough historical data to satisfy the threshold value, then the travel key detection system 100 may use the city name that corresponds to the postal code as the default largest version of the travel key. The determination of whether to use the default largest version of the travel key may be based on a limit set by an administrator, such as restricting the enlargement of the geographic area corresponding to the travel key to be no greater than a city. In other words, the if a subsequent removal of a last digit from the consecutive set of digits of the postal code would result in the corresponding geographic area being larger than the city corresponding to the postal code, then the travel key detection system 100 may determine to use the city name as the travel key rather than continuing to enlarge the geographic area covered by the travel key. If the travel key detection system 100 determines to use the default largest version of the travel key, then it may proceed to use the default largest version of the travel key in determining the duration of travel (Operation 360). For example, the travel key detection system 100 may use the default largest version of the travel key in the determination of the duration of travel between the first activity and the second activity (Operation 250) in FIG. 2.

In one or more embodiments, if the travel key detection system 100 determines that the default largest version of the travel key should not yet be used, then the travel key detection system 100 determines, for a second version of the travel key that corresponds to a second geographic area that is larger than and encompasses the first geographic area, a second quantity of the plurality of instances that correspond to distinct geographic locations that are within the second geographic area (Operation 350). The travel key detection system 100 may determine the second quantity by determining, for a second version of the travel key that includes a subset of the first set of consecutive digits of the postal code, a second quantity of the plurality of instances that correspond to distinct geographic locations that have corresponding postal codes that include the subset of the first set of consecutive digits of the postal cod. The second version of the travel key may be formed by removing the last digit from the consecutive set of digits of the postal code that are used in the first version of the travel key in order to enlarge the geographic area covered by the travel key.

In an embodiment, the travel key detection system 100 then determines whether the second quantity meets the threshold value (Operation 330). In this way, the travel key detection system 100 is attempting to verify whether the gradual enlargement of the geographic area covered by the second version of the travel key results in a sufficient amount of historical data to make the prediction of the duration of travel using the second version of the travel key accurate. The travel key detection system 100 may repeatedly cycle through Operations 330, 340, and 350 for subsequent versions of the travel key that cover larger geographic areas than the preceding versions of the travel key until the travel key detection system 100 either determines that the corresponding quantity of instances that correspond to distinct geographic locations that are within the larger geographic area meet the threshold value (Operation 330) or determines that the default largest version of the travel key should be used (Operation 340).

The terms “first”, “second”, “third”, “fourth”, etc., should not be interpreted as requiring different elements. For example, the first travel key and second travel key in various embodiments may be the same or different travel keys depending on the configuration of the travel keys and if the location of the activities falls are covered by the same travel key. Similarly, a first location element and second location element may be the same or a different location element depending on which travel keys are determined to be optimal for a given application.

### 4. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

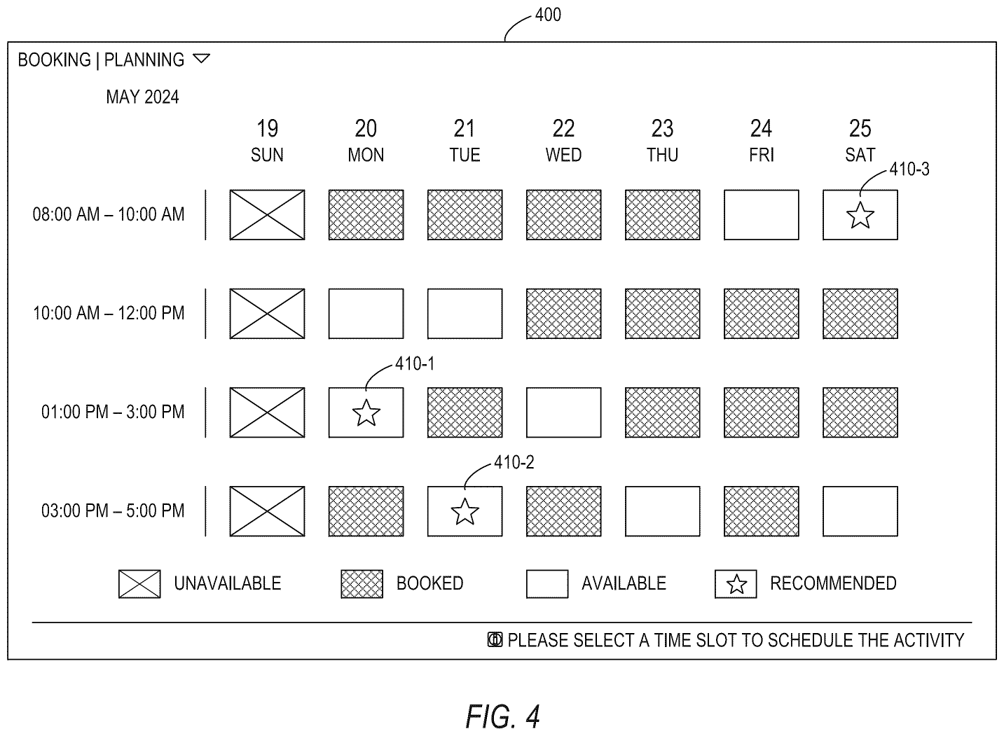

FIG. 4 illustrates an example graphical user interface 400 in which a recommendation to schedule an activity for a particular time slot is presented in accordance with one or more embodiments. In the example shown in FIG. 4, the graphical user interface 400 displays a recommendation of three different time slots 410-1, 410-2, and 410-3 for which to schedule the activity. The graphical user interface 400 may display time slots that are unavailable, time slots that have already been booked, and time slots that are available. The recommendation to schedule the activity for the particular time slots 410 may include an indication that the particular time slot 410 is recommended, such as a distinguishing user interface element. For example, the particular time slot 410 may be highlighted with a distinguishing color or may include a distinguishing icon (e.g., a star).

The recommendations presented within graphical user interface 400 may be based in part on predicted travel durations between activities. For example, graphical user interface 400 shows that the time slot for 8:00 a.m. to 10:00 a.m. is booked. The system may estimate a travel time to schedule the activity based on the travel key associated with the booked activity at the slot. In this example, the 10 a.m. to noon slot is not recommended because the predicted travel duration between activities does not allow for a timely start for the second activity. As a result, the system recommends time slot 410-1 instead. The following day, however, the system recommends time slot 410-2 which directly follows a booked activity based on a faster predicted travel time.

FIG. 4 illustrates an example scheduling system which uses the predicted travel times to optimize field service resource deployment. Additionally or alternatively, a field service management application may use the techniques above to perform other software functions. For example, the field service management application may send alerts, such as text messages, to customers to keep them up to apprised of estimated times. When a field service resource completes one activity, the system may update the predicted travel durations to one or more subsequent field service activities and send an update to one or more associated customers of the estimated arrival times. As another example, a field service management application may use predicted travel times for analytics involved in optimizing workflows to enhance the efficiency of when and where resources are deployed. The system may automate or recommend deployment strategies based in part on which strategies are predicted to minimize overall travel durations.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

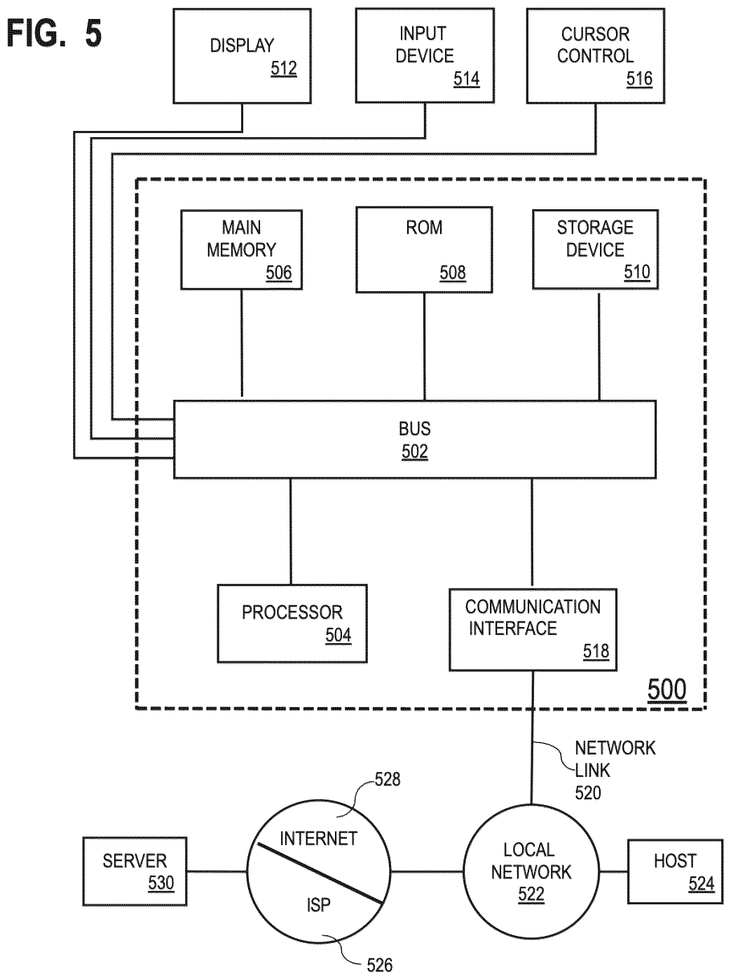

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method performed by at least one device including a hardware processor, the method comprising:
obtaining a first set of location elements of a first geographic location associated with a first activity;
determining a first travel key for the first geographic location using a first location element of the first set of location elements and a second location element of the first set of locations elements;
obtaining a second set of location elements of a second geographic location associated with a second activity;
determining a second travel key using a third location element of the second set of location elements and a fourth location element of the second set of location elements;
determining a duration of travel between the first activity and the second activity using the first travel key and the second travel key; and
performing a function of a software application using the duration of travel between the first activity and the second activity.

2. The method of claim 1, wherein:
the determining of the first travel key for the first geographic location comprises combining at least a portion of the first location element and at least a portion of the second location element to form the first travel key; and
the determining of the second travel key for the second geographic location comprises:
combining at least a portion of the third location element and at least a portion of the fourth location element to form the second travel key.

3. The method of claim 2, wherein:
the first location element comprises a first country identifier of the first geographic location;
the second location element comprises a first postal code of the first geographic location;
the third location element comprises a second country identifier of the second geographic location; and
the fourth location element comprises a second postal code of the second geographic location.

4. The method of claim 1, wherein the determining of the first travel key comprises:
selecting a first formula from a plurality of formulas based on a first country identifier of the first geographic location, each formula in the plurality of formulas corresponding to a different country identifier and being configured to generate travel keys; and
generating the first travel key using the first formula based on the selecting of the first formula.

5. The method of claim 1, further comprising:
accessing historical data stored in a database, the historical data comprising a plurality of instances of travel between geographic locations, each instance of travel in the plurality of instances of travel comprising a corresponding duration of travel;
for a first version of a travel key that includes a first set of consecutive digits of a postal code, determining a first quantity of the plurality of instances that correspond to distinct geographic locations that have corresponding postal codes that include the first set of consecutive digits of the postal code;
determining that the first quantity does not meet a threshold value;
responsive to the determining that the first quantity is less than the threshold value, determining, for a second version of the travel key that includes a subset of the first set of consecutive digits of the postal code, a second quantity of the plurality of instances that correspond to distinct geographic locations that have corresponding postal codes that include the subset of the first set of consecutive digits of the postal code; and
determining that the second quantity meets the threshold value, wherein the second version of the travel key is used as the first travel key based on the determining that the second quantity meets the threshold value.

6. The method of claim 1, further comprising:
accessing historical data stored in a database, the historical data comprising a plurality of instances of travel between geographic locations, each instance of travel in the plurality of instances of travel comprising a corresponding duration of travel;
for a first version of a travel key that includes a first set of consecutive digits of a postal code, determining a first quantity of the plurality of instances that correspond to distinct geographic locations that have corresponding postal codes that include the first set of consecutive digits of the postal code;
determining that the first quantity does not meet a threshold value;
responsive to the determining that the first quantity does not meet the threshold value, determining, for a second version of the travel key that includes a subset of the first set of consecutive digits of the postal code, a second quantity of the plurality of instances that correspond to distinct geographic locations that have corresponding postal codes that include the subset of the first set of consecutive digits of the postal code;
determining that the second quantity does not meet the threshold value; and
responsive to the determining that the second quantity does not meet the threshold value, using a third version of the travel key as the first travel key based on the determining that the second quantity does not meet the threshold value, the third version of the travel key including a city name corresponding to the postal code.

7. The method of claim 1, further comprising:
accessing historical data stored in a database, the historical data comprising a plurality of instances of travel between geographic locations, each instance of travel in the plurality of instances of travel comprising a corresponding duration of travel;
for a first version of a travel key that corresponds to a first geographic area, determining a first quantity of the plurality of instances that correspond to distinct geographic locations that are within the first geographic area;
determining that the first quantity does not meet a threshold value;
responsive to the determining that the first quantity is less than the threshold value, determining, for a second version of the travel key that corresponds to a second geographic area that is larger than and encompasses the first geographic area, a second quantity of the plurality of instances that correspond to distinct geographic locations that are within the second geographic area; and
determining that the second quantity meets the threshold value, wherein the second version of the travel key is used as the first travel key based on the determining that the second quantity meets the threshold value.

8. The method of claim 1, further comprising:
accessing historical data stored in a database, the historical data comprising a plurality of instances of travel between geographic locations, each instance of travel in the plurality of instances of travel comprising a corresponding duration of travel;
for a first version of a travel key that corresponds to a first geographic area, determining a first quantity of the plurality of instances that correspond to distinct geographic locations that are within the first geographic area;
determining that the first quantity does not meet a threshold value;
responsive to the determining that the first quantity does not meet the threshold value, determining, for a second version of the travel key that corresponds to a second geographic area that is larger than and encompasses the first geographic area, a second quantity of the plurality of instances that correspond to distinct geographic locations that are within the second geographic area;
determining that the second quantity does not meet the threshold value; and
responsive to the determining that the second quantity does not meet the threshold value, using a third version of the travel key as the first travel key based on the determining that the second quantity does not meet the threshold value, the third version of the travel key corresponding to a third geographic area that is larger than and encompasses the second geographic area.

9. The method of claim 1, wherein the determining the duration of travel between the first activity and the second activity comprises:
obtaining, from a database, a set of historical data comprising historical travel durations between the first travel key and the second travel key; and
computing the duration of travel between the first activity and the second activity based on the historical travel durations between the first travel key and the second travel key.

10. The method of claim 1, wherein the performing of the function of the software application comprises:
determining a first particular time slot for the first activity and a second particular time slot for the second activity based on the duration of travel between the first activity and the second activity; and
presenting, on a computing device, a recommendation to schedule the first activity for the first particular time slot and the second activity for the second particular time slot.

11. The method of claim 1, wherein the performing of the function of the software application comprises:
determining a particular time slot for the second activity based on the duration of travel between the first activity and the second activity; and
presenting, on computing device, a recommendation to schedule the second activity for the particular time slot.

12. The method of claim 1, wherein the software application comprises a field service management (FSM) software application.

13. The method of claim 1, wherein:
the software application comprises a field service management (FSM) software application;
the determining of the first travel key for the first geographic location comprises combining at least a portion of the first location element and at least a portion of the second location element to form the first travel key, the first location element comprises a first country identifier of the first geographic location, the second location element comprises a first postal code of the first geographic location; and
the determining of the second travel key for the second geographic location comprises combining at least a portion of the third location element and at least a portion of the fourth location element to form the second travel key, the third location element comprises a second country identifier of the second geographic location, the fourth location element comprises a second postal code of the second geographic location;
the determining the duration of travel between the first activity and the second activity comprises:
obtaining, from a database, a set of historical data comprising historical travel durations between the first travel key and the second travel key; and
computing the duration of travel between the first activity and the second activity based on the historical travel durations between the first travel key and the second travel key; and
the performing of the function of the software application comprises:
determining a particular time slot for the second activity based on the duration of travel between the first activity and the second activity; and
presenting, on computing device, a recommendation to schedule the second activity for the particular time slot.

14. One or more non-transitory computer readable media comprising instructions which, when executed by one or more hardware processors, cause performance of operations comprising:
obtaining a first set of location elements of a first geographic location associated with a first activity;
determining a first travel key for the first geographic location using a first location element of the first set of location elements and a second location element of the first set of locations elements;
obtaining a second set of location elements of a second geographic location associated with a second activity;
determining a second travel key using a third location element of the second set of location elements and a fourth location element of the second set of location elements;
determining a duration of travel between the first activity and the second activity using the first travel key and the second travel key; and
performing a function of a software application using the duration of travel between the first activity and the second activity.

15. The media of claim 14, wherein:
the determining of the first travel key for the first geographic location comprises combining at least a portion of the first location element and at least a portion of the second location element to form the first travel key; and
the determining of the second travel key for the second geographic location comprises:
combining at least a portion of the third location element and at least a portion of the fourth location element to form the second travel key.

16. The media of claim 15, wherein:
the first location element comprises a first country identifier of the first geographic location;
the second location element comprises a first postal code of the first geographic location;
the third location element comprises a second country identifier of the second geographic location; and
the fourth location element comprises a second postal code of the second geographic location.

17. The method of claim 14, wherein the determining of the first travel key comprises:
selecting a first formula from a plurality of formulas based on a first country identifier of the first geographic location, each formula in the plurality of formulas corresponding to a different country identifier and being configured to generate travel keys; and
generating the first travel key using the first formula based on the selecting of the first formula.

18. The media of claim 14, wherein the operations further comprise:
accessing historical data stored in a database, the historical data comprising a plurality of instances of travel between geographic locations, each instance of travel in the plurality of instances of travel comprising a corresponding duration of travel;
for a first version of a travel key that includes a first set of consecutive digits of a postal code, determining a first quantity of the plurality of instances that correspond to distinct geographic locations that have corresponding postal codes that include the first set of consecutive digits of the postal code;
determining that the first quantity does not meet a threshold value;
responsive to the determining that the first quantity is less than the threshold value, determining, for a second version of the travel key that includes a subset of the first set of consecutive digits of the postal code, a second quantity of the plurality of instances that correspond to distinct geographic locations that have corresponding postal codes that include the subset of the first set of consecutive digits of the postal code; and
determining that the second quantity meets the threshold value, wherein the second version of the travel key is used as the first travel key based on the determining that the second quantity meets the threshold value.

19. The media of claim 14, wherein the operations further comprise:
accessing historical data stored in a database, the historical data comprising a plurality of instances of travel between geographic locations, each instance of travel in the plurality of instances of travel comprising a corresponding duration of travel;
for a first version of a travel key that includes a first set of consecutive digits of a postal code, determining a first quantity of the plurality of instances that correspond to distinct geographic locations that have corresponding postal codes that include the first set of consecutive digits of the postal code;
determining that the first quantity does not meet a threshold value;
responsive to the determining that the first quantity does not meet the threshold value, determining, for a second version of the travel key that includes a subset of the first set of consecutive digits of the postal code, a second quantity of the plurality of instances that correspond to distinct geographic locations that have corresponding postal codes that include the subset of the first set of consecutive digits of the postal code;
determining that the second quantity does not meet the threshold value; and
responsive to the determining that the second quantity does not meet the threshold value, using a third version of the travel key as the first travel key based on the determining that the second quantity does not meet the threshold value, the third version of the travel key including a city name corresponding to the postal code.

20. A system comprising:
at least one device including a hardware processor;
the system being configured to perform operations comprising:
obtaining a first set of location elements of a first geographic location associated with a first activity;
determining a first travel key for the first geographic location using a first location element of the first set of location elements and a second location element of the first set of locations elements;
obtaining a second set of location elements of a second geographic location associated with a second activity;
determining a second travel key using a third location element of the second set of location elements and a fourth location element of the second set of location elements;
determining a duration of travel between the first activity and the second activity using the first travel key and the second travel key; and
performing a function of a software application using the duration of travel between the first activity and the second activity.
